(19) United States
(12) Patent Application Publication
(10) Pub. No.: US 2011/0130534 A1
(43) Pub. Date: Jun. 2, 2011

(54) HIGH-STRENGTH POLYHIPE MATERIAL, PROCESS FOR PREPARING THE SAME, EMULSION USEFUL FOR PREPARATION THEREOF AND ARTICLE FORMED OF SAID MATERIAL

(75) Inventors: Oliver Besnard, Veigne (FR); Eric Pasquinet, Saint Avertin (FR); Herve Deleuze, Saint Magne (FR); Marc Birot, Talence (FR); Fabrice Audouin, Port Sainte Foy (FR)

(73) Assignee: Commissariat A L'Energie Atomique, Paris (FR)

(21) Appl. No.: 12/737,141

(22) PCT Filed: Jun. 8, 2009
(86) PCT No.: PCT/EP2009/056998

§ 371 Date: Feb. 16, 2011

(30) Foreign Application Priority Data
Jun. 9, 2008 (FR) 08 53809

(51) Int. Cl. C08F 226/06; C08F 2/38

(52) U.S. Cl. 526/200; 526/261; 526/207; 526/209

(57) ABSTRACT

The invention relates to a polyHIPE material provided with high mechanical strength, which material comprises at least one N-alkenyltriazole monomer and a cross-linking monomer in a weight ratio of cross-linking monomer/N-alkenyltriazole monomer of 1/100 to 60/100.

It also relates to a process and an emulsion allowing this emulsion to be prepared, and to an article formed in whole or in part of this material, and notably a catalyst support for heterogeneous catalysis, a particle filter, metal ion adsorbent, or gas sensor.

### TECHNICAL FIELD

The present invention relates to a polyHIPE material which, amongst other properties, has particularly high mechanical strength.

It also relates to a process and an emulsion for preparing this material, and to an article or object consisting in whole or in part of said material.

The polyHIPE material of the invention can find applications in all areas in which the use of a material combining the inherent properties of an interconnected cell structure with remarkable mechanical strength can be of interest.

In particular, it can be used in the manufacture of catalyst carriers for heterogeneous catalysis and notably photocatalysts of titanium dioxide or tin dioxide type for air or water treatment via photocatalysis, the manufacture of particle filters, the manufacture of metal ion adsorbents for water purification, the manufacture of gas e.g. ozone sensors and more generally in all applications in which the use of materials in interconnected, open-cell monolithic blocks is required.

### STATE OF THE PRIOR ART

Polymerised High Internal Phase Emulsion—<<polyHIPE>> materials are obtained by polymerizing an emulsion called HIPE (for High Internal Phase Emulsion), which comprises:
firstly an external or dispersing phase essentially consisting of polymerizable monomers and of a surfactant in solution in a solvent, and
secondly, an internal or dispersed phase which typically represents 74% or more of the total volume of the emulsion and which essentially consists of a solvent that is non-miscible with polymerizable monomers or with the solvent of the dispersing phase.

After polymerization and removal of the solvent from the dispersed phase, open-cell materials are obtained whose cells correspond to the imprint of bubbles formed by this solvent during the preparation of the emulsion, and are interconnected via openings of smaller size than themselves, commonly called pores.

PolyHIPE materials have a void/filled volume ratio that is particularly high and hence a particularly low density with a regular, spherical, isotropic cell structure, making them very different from polymer foam materials conventionally obtained by blowing or extrusion which are characterized by an irregular, oriented, anisotropic cell structure.

Having regard to their characteristics, polyHIPE materials are the subject of increasing interest, and their use has been proposed in numerous areas among which mention may be made of the manufacture of disposable absorbent items, materials for heat, sound, electric or mechanical insulation, membranes, filters or supports for inks, dyes and catalysts.

The vast majority of polyHIPE materials described in the literature to date is represented by materials obtained from <<water-in-oil>> HIPE emulsions i.e. whose dispersing phase is an organic phase and whose dispersed phase is an aqueous phase. In this case, the polymerizable monomers are hydrophobic monomers generally vinyl unsaturated monomers such as styrene, divinylbenzene and 2-ethyl-hexyl acrylate.

Yet H. Deleuze et al. have shown in Polymer 2005, 46, 9653-9663 [1] that polyHIPE materials from hydrophobic monomers of styrene and divinylbenzene type, even with cross-linking rates of 50%, have a Young's modulus of 9 MPa, i.e. a value which is generally considered too low for some applications.

PolyHIPE materials derived from <<oil-in-water>> HIPE emulsions are also known, i.e. having an aqueous phase as dispersing phase, and an organic phase as dispersed phase. For example, international PCT application published under no WO 2004/044041 [2] describes the use of HIPE emulsions for the manufacture of absorbing hygiene articles, the dispersing phase being an aqueous phase in which hydrophilic polymerizable monomers are dissolved of acrylic acid type and derivatives thereof, whilst the dispersed phase consists of a silicone oil. Additionally P. Krajnc et al., in Macromol. Rapid Comm. 2005, 26, 1289-1293 [3] describe the preparation of a cellular polymer consisting of acrylic acid cross-linked with N,N′-methylene-bis(acrylamide) from an <<oil-in-water>> HIPE emulsion. However, all these studies lead to polyHIPE materials which have high swelling properties in aqueous media but low mechanical strength.

It is therefore desirable to provide materials which, whilst having the particular properties of polyHIPE materials, also have high mechanical strength or at least sufficiently high strength so that their use in all the applications which have been proposed for these types of materials can be truly envisaged.

The purpose of the present invention is precisely to provide a polyHIPE material with high mechanical strength.

### DISCLOSURE OF THE INVENTION

The subject-matter of the present invention is therefore firstly a polyHIPE material which in copolymerized form comprises:

a) at least one N-alkenyltriazole monomer of general formula (I):

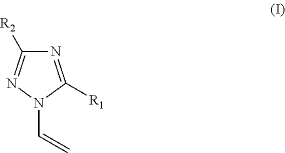

wherein R₁ and R₂ each independently represent a hydrogen or halogen atom, a group —OH, —SH, —SO₃H, —NO₂, —NH₂, —COOH, —CₙF₂ₙ₊₁ in which n is an integer ranging from 1 to 12, a C₁ to C₁₆ aliphatic hydrocarbon group optionally interrupted by one or more oxygen and/or sulphur atoms, or a C₃ to C₁₆ cyclic hydrocarbon group or heterocyclic with 3 to 16 members; and

b) at least one cross-linking monomer;

the cross-linking monomer/N-alkenyltriazole monomer weight ratio being 1/100 to 60/100.

In the foregoing and in the remainder hereof:
the expression <<C₁ to C₁₆ aliphatic hydrocarbon group>> designates any straight or branched but not cyclic hydrocarbon group, saturated or unsaturated, formed by at least one carbon atom and no more than 16 carbon atoms; it may therefore be an alkyl group (e.g. methyl, ethyl, n-propyl, isopropyl, butyl, isobutyl, sec-butyl, tert-butyl, pentyl, isopentyl, hexyl, heptyl, octyl, nonyl or decyl), alkenyl group (e.g. ethylenyl, propylenyl, butenyl, pentenyl, hexenyl, methylpentenyl or buta-1,3-dienyl) or alkynyl group (e.g. ethynyl, propynyl, butynyl, pentynyl, hexynyl or octynyl); if this group is interrupted by one or more oxygen or sulphur atoms, then this means that this or these atoms are intercalated between two carbon atoms;
the expression <<C₃ to C₁₆ cyclic hydrocarbon group>> designates any monocyclic or polycyclic hydrocarbon group, saturated or unsaturated, formed of at least 3 carbon atoms and no more than 16 carbon atoms; it may be a non-aromatic group i.e. a cycloalkyl group (e.g. cyclopropyl, cyclobutyl, cyclopentyl, cyclohexyl, cyclooctyl, norbornyl, bicyclo[4.3.2]-undecyl, bicyclo[4.4.0]decyl or adamantyl), cycloalkenyl or cycloalkynyl group, but it may also be an aromatic group i.e. a group meeting Hückel's rule and having a number of delocalized electrons π of 4n+2 (e.g. phenyl, benzyl, biphenyl, phenyl-acetylenyl, pyrenyl or anthracenyl);
the expression <<heterocyclic hydrocarbon group with 3 to 16 members>> designates a cyclic hydrocarbon group such as just defined but in which one or more atoms of its constituent ring(s) are replaced by a heteroatom, typically an oxygen, sulphur or nitrogen atom; here again it may be a non-aromatic group i.e. a heterocycloalkyl group (e.g. tetrahydrothienyl, pyrrolidinyl, tetrahydrofuryl, piperidinyl, dioxanyl or morpholinyl), heterocycloalkenyl or heterocycloalkynyl group, but it may also be a heteroaromatic group (e.g. furyl, pyrrolyl, thienyl, oxazolyl, pyrazolyl, thiazolyl, imidazolyl, triazolyl, pyridinyl, pyranyl, quinoleinyl, pyrazinyl or pyrimidinyl).

According to the invention, the N-alkenyltriazole monomer may be in salt form if R₁ and/or R₂ represent a group capable of forming a salt, which is notably the case with —OH, —SH, —SO₃H, —NH₂, and —COOH groups and nitrogen heterocyclic groups of piperidinyl or morpholinyl type. This salt may be a halide, a hydroxide, a mineral acid salt (e.g. nitrate) or organic acid salt (e.g. acetate) when the salifiable group is in the form of a cation (e.g. —NH³⁺); however, it may also be a salt of an alkaline or alkaline-earth metal when the salifiable group is in anion form (—SO₃⁻ or —COO⁻ for example).

Also, when R₁ and/or R₂ represent a cyclic or heterocyclic hydrocarbon group, and more especially an aromatic or heteroaromatic group, then this group can be substituted by one or more polar groups of —OH, —SH, —CO₂H or —SO₃H type, to promote the solubility of the N-alkenyltriazole monomer in polar solvents.

According to the invention, the N-alkenyltriazole monomer of general formula (I) is preferably chosen from among those monomers in which R₁ and R₂ each independently represent a hydrogen atom, a —OH, —SH, —SO₃H, —NO₂, —NH₂, —COOH or CₙF₂ₙ₊₁ group in which n is as previously defined, 1-vinyl-1,2,4-triazole being most particularly preferred.

Regarding the cross-linking monomer, this is preferably chosen from polyvinyl compounds soluble in polar solvents such as water, dimethylformamide, dimethylsulphoxide, dimethylacetamide, N-methylpyrrolidone, acetonitrile and mixtures thereof.

Further preferably it is a water-soluble polyvinyl compound such as ethyleneglycol diacrylate, diethyleneglycol diacrylate, tetraethyleneglycol diacrylate, ethyleneglycol dimethacrylate, triethyleneglycol dimethacrylate, N,N′-methylenebis (acrylamide), N,N′-ethylenebis(acrylamide), N,N′-trimethylene-bis(acrylamide), N,N′-methylenebis (methacrylamide) and N,N′-ethylenebis(methacrylamide), N,N′-methylenebis(acrylamide) being most particularly preferred.

According to the invention, the weight ratio of cross-linking monomer to N-alkenyltriazole monomer preferably ranges from 1/100 to 20/100 and further preferably from 3/100 to 10/100 which, in this latter case, corresponds to a cross-linking rate of the N-alkenyltriazole monomer of 3 to 10%.

The material of the invention can be prepared following a method which comprises the steps of:

a) forming an emulsion between:
a first, so-called dispersing phase, comprising the N-alkenyltriazole monomer of general formula (I) and the cross-linking monomer, the weight ratio of cross-linking monomer to N-alkenyltriazole monomer being 1/100 to 60/100, a surfactant, a polymerization initiator (or primer) and optionally a solvent of the N-alkenyltriazole and cross-linking monomers, and
a second, so-called dispersed phase, comprising a solvent immiscible with said monomers and/or optionally with the solvent of the first phase;

b) polymerizing the emulsion obtained at step a) until a solid material is obtained; and

c) washing and drying the material obtained at step b).

According to one preferred arrangement of the invention, the dispersing phase, in addition to the N-alkenyltriazole monomer of general formula (I), the cross-linking monomer, the surfactant and the cross-linking initiator, comprises a polar solvent such as water, dimethylformamide, dimethyl sulphoxide, dimethylacetamide, N-methylpyrrolidone, acetonitrile or a mixture thereof, whilst the dispersed phase comprises an apolar solvent.

In which case, the weight ratio of polar solvent to N-alkenyltriazole monomer preferably ranges from 1/3 to 4/1 and further preferably from 0.8/1 to 2/1, whilst the weight ratio of apolar solvent to the said monomer is advantageously 1/1 to 10/1, preferably 1/1 to 6/1 and more preferably 1.5/1 to 5/1.

Further preferably it is preferred that the emulsion is an <<oil-in-water>> emulsion, i.e. the solvent of the dispersing phase is water, preferably distilled water, or a mixture of water and another polar solvent, whilst the solvent of the dispersed phase is a long-chain alkane i.e. C₆ to C₃₂, advantageously a dodecane or tetradecane.

According to the invention, the surfactant is preferably a non-ionic surfactant, in which case it may notably be chosen from among alkyl ethoxylates, fatty alcohol ethoxylates, fatty amine ethoxylates, fatty acid ethoxylates, oxa-alcohol ethoxylates, alkylphenol ethoxylates e.g octylphenol and nonylphenol ethoxylates, polyethylene oxide and polypropylene oxide complex polymers, polyethylene oxide-polypropylene oxide block copolymers e.g. the PEO-PPO-PEO triblock copolymers, ethylene oxide and propylene oxide fatty alcohol condensates, fatty acid and sorbitan monoesters (monolaurate, monomyristate, monostearate, monopalmitate, monooleate, etc.) and polyesters, fatty acid and glycerol monoesters (monolaurate, monomyristate, monostearate, monopalmitate, monooleate, etc.) and polyesters, polyoxyethylene sorbitan monoesters, and mixtures thereof.

The surfactants which have proved to be particularly suitable are for example polyoxyethylene sorbitan monoesters known under the trade name Tween®, fatty alcohol ethoxylates known under the trade name Brij®, alkylphenol ethoxylates known under the trade name Igepal®, the triblock copolymers PEO-PPO-PEO such as those known under the trade name Pluronic®, and mixtures thereof.

Irrespective of the surfactant used, the weight ratio of this agent to the N-alkenyltriazole monomer is advantageously 0.2/1 to 1/1, preferably 0.25/1 to 0.8/1 and more preferably 0.3/1 to 0.6/1.

The polymerization initiator is preferably a radical polymerization initiator, in which case it can be chosen from among all those compounds known to be capable of initiating polymerization of radical type. However a compound soluble in polar solvents is preferred, such as potassium peroxodisulphate, 2,2′-azobis(2-methyl-propionamidine) dichlorate and some organic peroxides such as benzoyl peroxide.

At all events, the polymerization initiator is advantageously present in the emulsion in a weight ratio to the N-alkenyltriazole monomer of 0.5/100 to 10/100, preferably 2/100 to 8/100 and further preferably 4/100 to 6/100.

According to the invention, the emulsion can be prepared using any device allowing the forming of an emulsion between two phases of different type. For example, an emulsion of small volume can be prepared using a vortex-type agitator (the constituents of the emulsion then being placed in a test tube), whilst an emulsion of larger volume can be formed in a reactor provided with a mechanical agitation system or using a system with two syringes connected together and set in operation by syringe pumps.

Polymerization of the emulsion is preferably conducted under heat i.e. at a temperature higher than ambient temperature but not exceeding 100° C., typically from 40 to 80° C. It is generally conducted after pouring the emulsion into a mould, advantageously in polytetrafluoroethylene (Teflon®), of shape and size corresponding to the final material in relation to the intended use thereof. This mould is preferably hermetically sealed to avoid evaporation of the volatile solvents and possible contamination of the emulsion during polymerization. The emulsion polymerization time needed to obtain a solid material is typically of the order of 12 to 48 hours.

The solid material obtained after polymerization, once released from the mould if polymerization is conducted in a mould, is washed to remove all the constituents which have not polymerized i.e. the monomers which have not reacted, the surfactant, conversion products of the polymerization initiator, solvent of the dispersed phase and, optionally, the solvent of the dispersing phase. This washing is preferably conducted by successively using several different solvents or different solvent mixtures. In particular, this washing can be performed in an extractor of Soxhlet type successively using ethanol, distilled water, a distilled water/ethanol or acetone mixture, washing in ethanol followed by washing with acetone being preferred.

Next, the material is washed and dried preferably in vacuo at a temperature ranging from 20 to 150° C. and more preferably from 40 to 80° C.

A further subject of the invention is an emulsion which can be used to prepare a polyHIPE material such as defined in the foregoing, which comprises:
a first phase comprising the N-alkenyltriazole monomer of general formula (I) and the cross-linking monomer, in a weight ratio of cross-linking monomer to N-alkenyltriazole monomer of 1/100 to 60/100, a surfactant, a polymerization initiator and, optionally, a solvent of the N-alkenyltriazole and cross-linking monomers, and
a second phase comprising a solvent immiscible with said monomers and/or, optionally, with the solvent of the first phase.

In this emulsion, the preferred characteristics of the N-alkenyltriazole monomer, of the cross-linking monomer, surfactant, polymerization initiator and solvents are the same as those previously indicated for the polyHIPE material of the invention and its method of preparation. The same applies to the preferred proportions of these different compounds.

The polyHIPE material of the invention has numerous advantages. It is rigid, heat-stable, homogeneous and has particularly high strength even with a low cross-linking rate. It is therefore capable of withstanding strong stresses and can be machined from a monolithic block without undergoing deterioration.

It is therefore particularly useful for the manufacture of articles which must not only have an interconnected open-cell structure but must also be capable of withstanding mechanical and/or heat stresses e.g. catalyst substrates for heterogeneous catalysis, particle filters, metal ion adsorbents or gas sensors.

Additionally, it can be produced using a relatively simple method which is easy to implement and only uses compounds which are either commercially available or can be easily synthesized by a skilled person. In this respect, it is to be noted that the synthesis of N-alkenyltriazole of general formula (I) is described in U.S. Pat. No. 5,646,293 [4] and is therefore well known to those skilled in the art.

Other characteristics and advantages of the invention will become better apparent on reading the remainder of the description which refers to examples of prepared emulsions which can be used to obtain polyHIPE materials of the invention, with exemplary embodiments of polyHIPE materials of the invention from these emulsions and the properties thereof.

These examples are evidently given for the purpose of illustrating the invention and are non-limiting in this respect.

### BRIEF DESCRIPTION OF THE DRAWINGS

FIG. 1 is a photograph taken under scanning electron microscopy using ×750 magnification, of a first example of a polyHIPE material according to the invention.

FIG. 2 is a photograph taken under scanning electron microscopy, magnification of ×750, of a second example of a polyHIPE material according to the invention.

FIG. 3 is a photograph taken under scanning electron microscopy, magnification of ×750, of a third example of a polyHIPE material according to the invention.

FIG. 4 is a photograph taken under scanning electron microscopy, ×750 magnification, of a fourth example of polyHIPE material according to the invention.

FIG. 5 is a photograph taken under scanning electron microscopy, magnification of ×750, of a fifth example of polyHIPE material according to the invention.

FIG. 6 is a photograph taken under scanning electron microscopy, magnification of ×750, of a sixth example of polyHIPE material according to the invention.

FIG. 7 is a photograph taken under scanning electron microscopy, magnification of ×750, of a seventh example of polyHIPE material according to the invention.

FIG. 8 is a photograph taken under scanning electron microscopy, magnification of ×3500, of an eighth example of polyHIPE material according to the invention.

FIG. 9 shows a scanning electron microscope photograph, magnification of ×5000, of a ninth example of polyHIPE material according to the invention.

FIG. 10 shows a scanning electron microscope photograph, with magnification of ×7500, of a tenth example of polyHIPE material according to the invention.

FIG. 11 shows the stress-strain curve and Young's modulus obtained by subjecting test pieces of an eleventh example of polyHIPE material according to the invention to a compression test.

FIG. 12 is a thermogram obtained by subjecting the polyHIPE material illustrated FIG. 4 to thermogravimetric analysis.

### DETAILED DESCRIPTION OF PARTICULAR EMBODIMENTS

### Example 1

### Preparation of Emulsions Using a Vortex

Ten emulsions were prepared containing 1-vinyl-1,2,4-triazole, hereinafter denoted emulsions 1 to 10, proceeding as follows:

The following were added to a test tube:
1-vinyl-1,2,4-triazole, hereunder denoted VT (Interchim, ref. BE893),
distilled water,
potassium peroxodisulphate K₂S₂O₈,
N,N′-methylenebis(acrylamide), hereunder denoted MBA (Sigma-Aldrich, ref. 148326),
a surfactant (TA) chosen from among:
   a polyoxyethylene sorbitan monolaurate, hereunder denoted T1 (Sigma-Aldrich, Tween® 20),
   a polyoxyethylene oleyl ether, hereunder denoted T3 (Sigma-Aldrich, Brij® 98),
   a polyoxyethylene nonylphenol ether, hereunder denoted T4 (Sigma-Aldrich, Igepal® CO-890),
   a PEO-PPO-PEO triblock copolymer with 80% PEO, hereinafter denoted T5 (Sigma-Aldrich, Pluronic® F 108), and
   T1/T4, T3/T4 and T4/T5 mixtures, and finally
a water-immiscible solvent chosen from among n-dodecane C₁₂H₂₈ and n-tetradecane C₁₄H₃₀.

The tube is then agitated using a vortex (Bioblock Scientific, model: Top-Mix®) for 30 minutes to obtain a stable, opaque emulsion.

Table I below, for each of emulsions 1 to 10, specifies the quantities, expressed in milligrams, of VT, MBA, K₂S₂O₈ and distilled water used, the type of surfactant and the type of water-immiscible solvent used and the quantities thereof also expressed in milligrams.

TABLE I

| | | | | | | Water- |
|---|---|---|---|---|---|---|
| | | | | | | immiscible |
| | | | | TA | | solvent |
| Emulsion | VT | MBA | K₂S₂O₈ | (mg) | H₂O | (mg) |
| 1 | 200 | 10 | 10 | T1 | 200 | C₁₂H₂₆ |
| | | | | (80) | | (1600) |
| 2 | 200 | 10 | 10 | T3 | 200 | C₁₂H₂₆ |
| | | | | (80) | | (1600) |
| 3 | 200 | 10 | 10 | T4 | 200 | C₁₂H₂₆ |
| | | | | (80) | | (1600) |
| 4 | 100 | 10 | 10 | T4 | 300 | C₁₂H₂₆ |
| | | | | (80) | | (1600) |
| 5 | 200 | 10 | 10 | T4 | 200 | C₁₂H₂₆ |
| | | | | (80) | | (1600) |
| 6 | 600 | 30 | 30 | T4 | 600 | C₁₂H₂₆ |
| | | | | 240 | | (4200) |
| 7 | 600 | 30 | 30 | T4 | 600 | C₁₄H₃₀ |
| | | | | (240) | | (4200) |
| 8 | 400 | 20 | 20 | T1 + T4 | 400 | C₁₂H₂₆ |
| | | | | (60 + 60) | | (1600) |
| 9 | 400 | 20 | 20 | T3 + T4 | 400 | C₁₂H₂₆ |
| | | | | (60 + 60) | | (1600) |
| 10 | 400 | 20 | 20 | T4 + T5 | 400 | C₁₂H₂₆ |
| | | | | (90 + 30) | | (1600) |

### Example 2

### Preparation of Emulsions in a Reactor Provided with Mechanical Agitation

Two emulsions are prepared containing 1-vinyl-1,2,4-triazole, hereunder denoted emulsions 11 and 12, proceeding as follows.

To a reactor provided with mechanical agitation, here a D-shaped paddle, are added 1-vinyl-1,2,4-triazole, distilled water, potassium peroxodisulphate and N,N′-methylene-bis(acrylamide). Whilst maintaining the medium under agitation, n-dodecane is added dropwise, and agitation is continued for 1 hour to obtain a stable, opaque, white emulsion.

Table II below, for each of emulsions 11 and 12, specifies the quantities expressed in grams of VT, MBA, K₂S₂O₈, surfactant, distilled water and n-dodecane used.

TABLE II

| Emulsion | VT | MBA | K₂S₂O₈ | T3 + T4 | H₂O | C₁₂H₂₆ |
|---|---|---|---|---|---|---|
| 11 | 8 | 0.4 | 0.4 | 2.4 + 2.4 | 5.3 | 32 |
| 12 | 10 | 0.5 | 0.5 | 3 + 3 | 10 | 40 |

### Example 3

### Preparation of Emulsions Using a Syringe Pump

Six emulsions are prepared containing 1-vinyl-1,2,4-triazole, hereunder denoted emulsions 13 to 18, proceeding as follows.

In a beaker, under mechanical agitation, 1-vinyl-1,2,4-triazole, distilled water, N,N′-methylenebis(acrylamide) are placed in solution with a polymerization initiator chosen from among:
potassium peroxodisulphate,
benzoyl peroxide, hereunder PB, and
2,2′-azobis(2-methyl-propionamidine dichlorate, hereunder denoted V-50, (Wako Chemicals, V-50).

This solution and n-dodecane are poured into the body of a first, 60 mL syringe. This syringe is connected to a second syringe which is empty, whose plunger is lowered and which is equipped with a tube 4 mm in diameter and 20 mm in length. The two syringes thus connected are attached to a syringe pump. Emulsification time is set at 25 minutes.

Table III, for each of emulsions 13 to 18, specifies the quantities used of VT, MBA, distilled water and dodecane expressed in grams, the type of polymerization initiator and the type of surfactant used, with their quantities also expressed in grams.

TABLE III

| | | | Initiator | TA | | |
|---|---|---|---|---|---|---|
| Emulsion | VT | MBA | (g) | (g) | H₂O | C₁₂H₂₆ |
| 13 | 6 | 0.3 | K₂S₂O₈ | T4 | 6 | 24 |
| | | | (0.3) | (3) | | |
| 14 | 6 | 0.3 | K₂S₂O₈ | T3 + T4 | 6 | 10 |
| | | | (0.3) | (1.5 + 1.5) | | |
| 15 | 6 | 0.3 | K₂S₂O₈ | T4 | 6 | 10 |
| | | | (0.3) | (3) | | |
| 16 | 6 | 0.3 | PE | T3 + T4 | 6 | 24 |
| | | | (0.3) | (1.5 + 1.5) | | |
| 17 | 6 | 0.3 | V-50 | T3 + T4 | 6 | 10 |
| | | | (0.3) | (1.5 + 1.5) | | |
| 18 | 6 | 0.3 | V-50 | T4 | 6 | 10 |
| | | | (0.3) | (3) | | |

### Example 4

### Preparation of PolyHIPE Materials According to the Invention

Eleven polyHIPE materials containing 1-vinyl-1,2,4-triazole are prepared, cross-linked to 5 weight % with N,N′-methylenebis(acrylamide), hereunder denoted materials 19 to 28, proceeding as follows.

An emulsion prepared in accordance with Examples 1 to 3 is poured into a Teflon® mould, the mould is closed and heated to 60° C. for 24 hours. After this time the material is released from the mould, Soxhlet-washed with ethanol for 48 hours, then with acetone for 24 hours, and vacuum dried at 55° C. for 5 days.

Table IV below, for each of the materials 19 to 28, specifies the emulsion from which the material is formed, the inner dimensions of the mould in which this emulsion is poured and the porosity of the material after drying. This porosity was determined by mercury intrusion porosimetry.

TABLE IV

| | | Inner | | |
|---|---|---|---|---|
| | Emulsion | dimensions | | Porosity of |
| Material | used | of the mould | | the material |
| 19 | 6 | φ = 15 | mm | 66% |
| | | H = 30 | mm | |
| 20 | 7 | φ = 15 | mm | 69% |
| | | H = 30 | mm | |
| 21 | 12 | φ = 15 | mm | 86% |
| | | H = 30 | mm | |
| 22 | 13 | φ = 15 | mm | 80% |
| | | H = 30 | mm | |
| 23 | 14 | φ = 15 | mm | 68% |
| | | H = 30 | mm | |
| 24 | 16 | φ = 15 | mm | 75% |
| | | H = 30 | mm | |
| 25 | 17 | φ = 15 | mm | 72% |
| | | H = 30 | mm | |
| 26 | 15 | φ = 32 | mm | 70% |
| | | H = 110 | mm | |
| 27 | 16 | φ = 15 | mm | 75% |
| | | H = 30 | mm | |
| 28 | 17 | φ = 15 | mm | 72% |
| | | H = 30 | mm | |

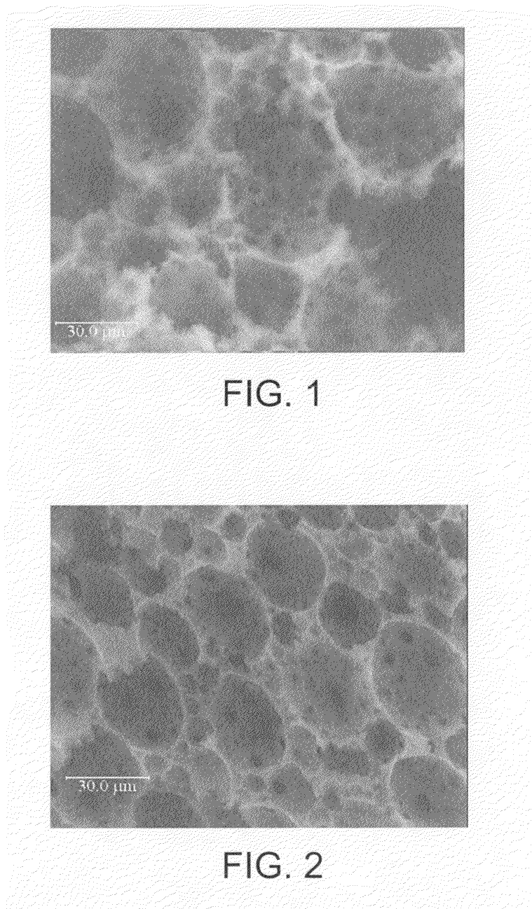

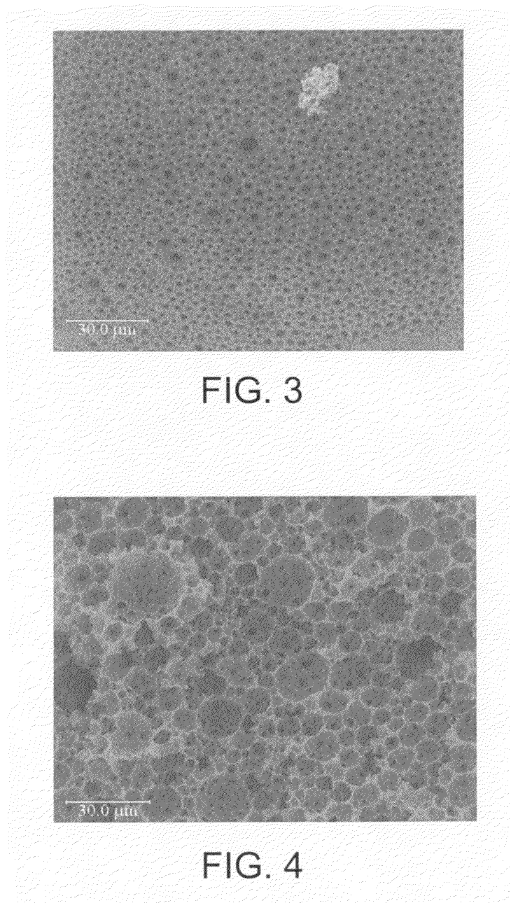

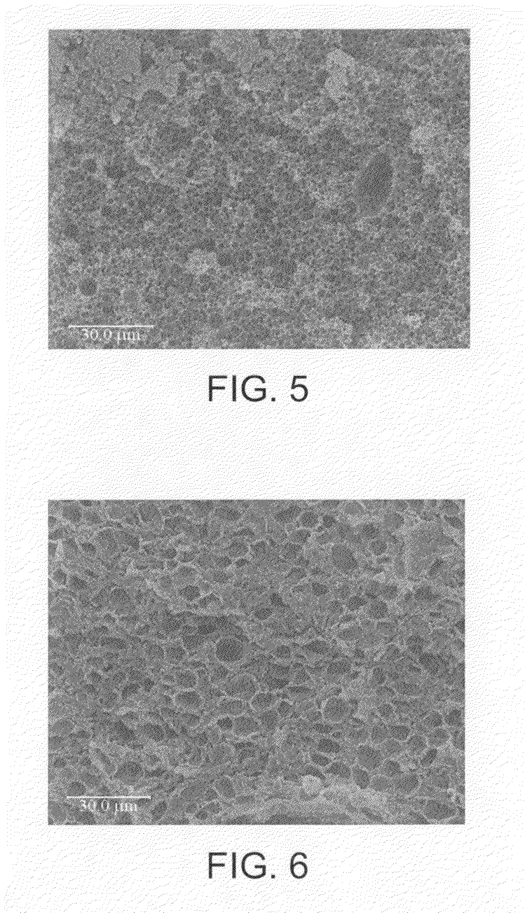

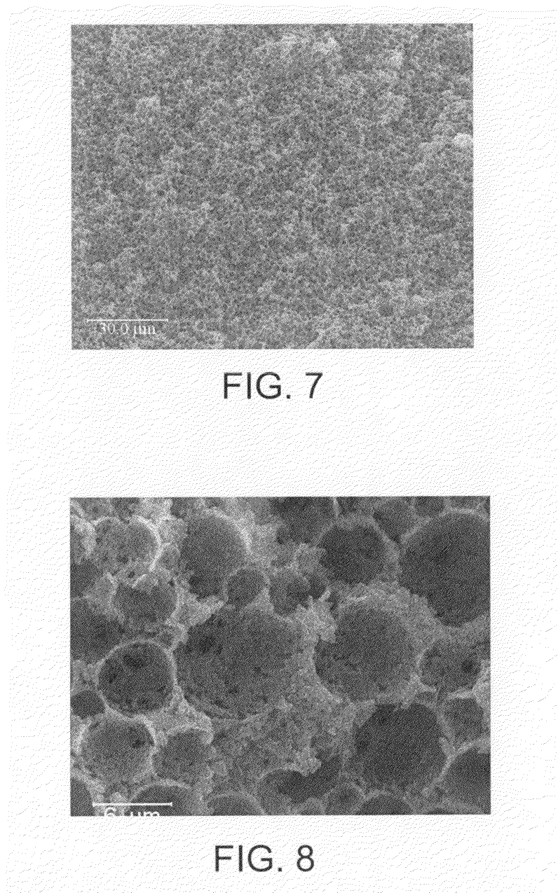

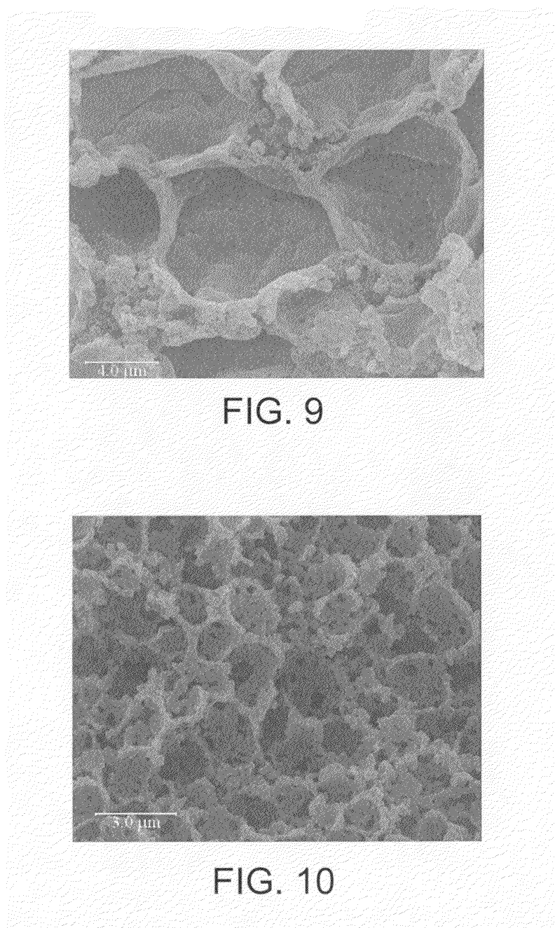

FIGS. 1 to 10, which relate to photographs of materials 19 to 28 taken under scanning electron microscopy, with magnifications ranging from ×750 to ×7500 depending on cases, show the interconnected open-cell structure of these materials.

### Example 5

### Properties of the PolyHIPE Materials According to the Invention

5.1. Mechanical Strength:

Test pieces are prepared of a polyHIPE material containing 1-vinyl-1,2,4-triazole cross-linked to 5 weight % with N,N′-methylenebis(acrylamide) proceeding as described in Example 4 above, but using emulsion 15 and moulds of inner diameter 7 mm and inner height of 4 mm. The test pieces thus obtained are therefore cylindrical and measure 7 mm in diameter and 4 mm thick. Their porosity is 70%.

They are subjected to compression tests conducted at ambient temperature, using an Instron 4460 instrument fitted with a 500 N static measuring cell. The test pieces are compressed at a constant rate (5 mm/min) normal to their planar surfaces between two metal plates.

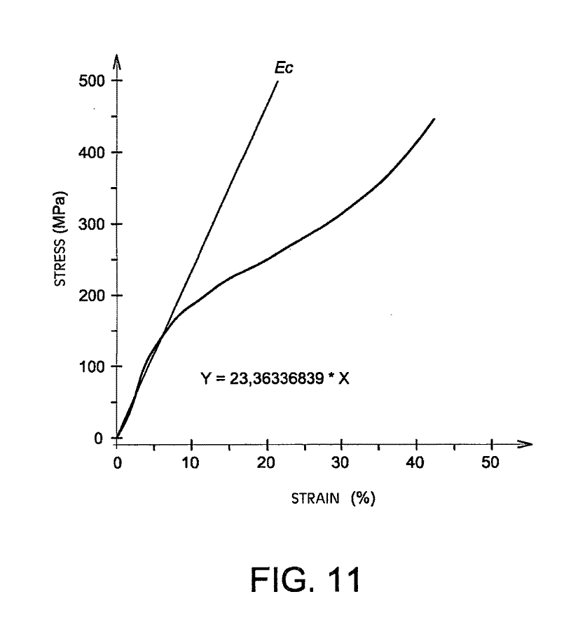

FIG. 11 shows the stress-strain curve formed from data collected on a minimum of four samples, and Young's modulus E_{c} calculated from this same data.

It is ascertained that this modulus is 23.4 MPa, i.e. twice greater than the value reported by H. Deleuze et al. (ibid) with polyHIPE materials formed of polystyrene 50% cross-linked with divinyl-benzene, of porosity comparable to that of material 29 (80% versus 70%).

This means that the polyHIPE materials of the invention have fully remarkable mechanical strength even with a very low cross-linking rate (here 5%).

5.2. Heat Stability:

Material 22 is pre-heated to 110° C. in vacuo overnight and then subjected to thermogravimetric analysis using a Netzsch STA 409 analyzer in an argon atmosphere, raising the temperature from 25° C. to 650° C. at the rate of 10° C./minute.

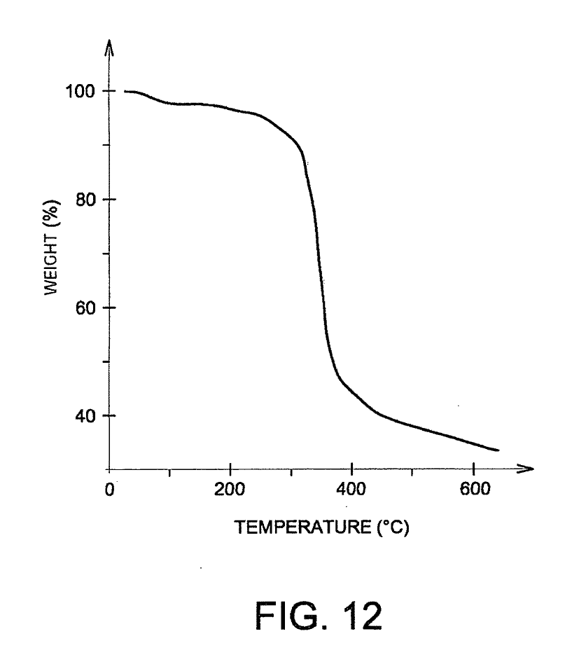

FIG. 12 gives the thermogram thus obtained, which shows that the polyHIPE material of the invention has good heat stability of the order of 280-300° C.

### CITED REFERENCES

[1] H. Deleuze et al., Polymer 2005, 46, 9653-9663
[2] WO-A-2004/044041
[3] P. Krajnc et al., Macromol. Rapid Comm. 2005, 26, 1289-1293
[4] U.S. Pat. No. 5,646,293

1. Material obtained by polymerizing a high internal phase emulsion which, in copolymerized form, comprises:
a) at least one N-alkenyltriazole monomer meeting following general formula (I): 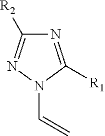
wherein R₁ and R₂ each independently represent a hydrogen or halogen atom, a group —OH, —SH, —SO₃H, —NO₂, —NH₂, —COOH, —CₙF₂ₙ₊₁, in which n is an integer ranging from 1 to 12, a C₁ to C₁₆ aliphatic hydrocarbon group optionally interrupted by one or more oxygen and/or sulphur atoms or by a cyclic C₃ to C₁₆ hydrocarbon group or heterocyclic with 3 to 16 members; and
b) a cross-linking monomer; the weight ratio of the cross-linking monomer to the 20 N-alkenyltriazole monomer ranging from 1/100 to 60/100.

2. The material according to claim 1, wherein the N-alkenyltriazole monomer is chosen from among the monomers of general formula (I) in which R₁ and R₂ each independently represent a hydrogen atom, a —OH, —SH, —SO₃H, —NO₂, —NH₂, —COON or CₙF₂ₙ₊₁ group in which n is as previously defined.

3. The material according to claim 2, wherein the N-alkenyltriazole monomer is 1-vinyl-1,2,4-triazole.

4. The material according to claim 1, wherein the cross-linking monomer is a polyvinyl monomer soluble in polar solvents.

5. The material according to claim 4, wherein the cross-linking monomer is a water-soluble polyvinyl monomer.

6. The material according to claim 5, wherein the cross-linking monomer is chosen from among ethyleneglycol diacrylate, diethyleneglycol diacrylate, tetraethyleneglycol diacrylate, ethyleneglycol dimethacrylate, triethyleneglycol dimethacrylate, N,N′ methylenebis(acrylamide), N,N′-methylenebis(acrylamide), N,N′-ethylenebis(acrylamide), N,N′-trimethylene-bis(acrylamide), N,N′-methylenebis(methacrylamide) and N,N′-ethylenebis(methacrylamide).

7. The material according to claim 6, wherein the cross-linking monomer is N,N′-methylene-bis(acrylamide).

8. The material according to claim 1, wherein the weight ratio of the cross-linking monomer to the N-alkenyltriazole monomer ranges from 1/100 to 20/100.

9. Method for preparing a material as defined in claim 1, which comprises:
a) forming an emulsion between:
a first phase comprising the N-alkenyltriazole monomer of general formula (I) and the cross-linking monomer in a weight ratio of cross-linking monomer to N-alkenyltriazole monomer of 1/100 to 60/100, a surfactant, a polymerization initiator and, optionally, a solvent of the N-alkenyltriazole and cross-linking monomers, and
a second phase comprising a solvent immiscible with said monomers and/or, optionally, with the solvent of the first phase;
b) polymerizing the emulsion obtained at step a) until a solid material is obtained; and
c) washing and drying the material obtained at step b).

10. The method according to claim 9, wherein the first phase comprises a polar solvent, whilst the second phase comprises an apolar solvent.

11. The method according to claim 10, wherein the weight ratio of the polar solvent to the N-alkenyltriazole monomer ranges from 1/3 to 4/1 and preferably from 0.8/1 to 2/1, whilst the weight ratio of apolar solvent to said monomer ranges from 1/1 to 10/1.

12. The method according to claim 10, wherein the first phase comprises water or a mixture formed of water and another polar solvent, whilst the second phase comprises a C₆ to C₃₂ alkane.

13. The method according to claim 9, wherein the surfactant is a non-ionic surfactant.

14. The method according to claim 13, wherein the surfactant is chosen from among alkyl ethoxylates, fatty alcohol ethoxylates, fatty amine ethoxylates, oxa-alcohol ethoxylates, alkylphenol ethoxylates, polyethylene oxide and polypropylene oxide complex polymers, polyethylene oxide-polypropylene oxide block copolymers, ethylene oxide and propylene oxide fatty alcohol condensates, fatty acid and sorbitan monoesters and polyesters, fatty acid and glycerol monoesters and polyesters, polyoxyethylene sorbitan monoesters, and mixtures thereof.

15. The method according to claim 9, wherein the weight ratio of surfactant to the N-alkenyltriazole monomer ranges from 0.2/1 to 1/1.

16. The method according to claim 9, wherein the polymerization initiator is a radical polymerization initiator.

17. The method according to claim 9, wherein the weight ratio of polymerization initiator to the N-alkenyltriazole monomer ranges from 0.5/100 to 10/100.

18. The method according to claim 9, wherein the emulsion is polymerized at a temperature higher than ambient temperature but not exceeding 100° C.

19. Emulsion useful for the preparation of a material such as defined in claim 1, which comprises:
a first phase comprising the N-alkenyltriazole monomer of general formula (I) and the cross-linking monomer, in a weight ratio of cross-linking monomer to N-alkenyltriazole monomer of 1/100 to 60/100, a surfactant, a polymerization initiator and, optionally, a solvent of the N-alkenyltriazole and cross-linking monomers, and
a second phase comprising a solvent immiscible with said monomers and/or, optionally, with the solvent of the first phase.

20. Article consisting in whole or in part of a material according to claim 1.

21. The article according to claim 20, which is a catalysis carrier for heterogeneous catalysis, a particle filter, a metal ion adsorbent or a gas sensor.

22. The material according to claim 8, wherein the weight ratio of the cross-linking monomer to the N-alkyenyltriazole monomer ranges from 3/100 to 10/100.

23. The method according to claim 4, wherein the weight ratio of the polar solvent to the N-alkenyltriazole monomer ranges from 1/1 to 6/1.

24. The method according to claim 11, wherein the first phase comprises water or a mixture formed of water and another polar solvent, whilst the second phase comprises a C₆ to C₃₂ alkane.

25. The method according to claim 15, wherein the weight ratio of surfactant to the N-alkenyltriazole monomer ranges from 0.25/1 to 0.8/1.

26. The method according to claim 17, wherein the weight ratio of polymerization initiator to the N-alkenyltriazole monomer ranges from 2/100 to 8/100.

27. The method according to claim 18, wherein the emulsion is polymerized at a temperature between 40° C. and 80° C.
